(19) United States
(12) Patent Application Publication
(10) Pub. No.: US 2004/0154402 A1
(43) Pub. Date: Aug. 12, 2004

(54) Remote laser beam delivery system and method for use with a robotic positioning system for ultrasonic testing purposes

(75) Inventor: Thomas E. Drake JR., Fort Worth, TX (US)

Correspondence Address: BAKER BOTTS L.L.P., 2001 ROSS AVENUE, SUITE 600, DALLAS, TX, 75201-2980, US

(73) Assignee: Lockheed Martin Corporation

(21) Appl. No.: 10/753,208

(22) Filed: Jan. 7, 2004

Related U.S. Application Data
(63) Continuation-in-part of application No. 10/645,404, filed on Aug. 21, 2003.
Application No. 10/645,404 is a continuation of application No. 09/907,493, filed on Jul. 16, 2001, now Pat. No. 6,643,002.
(63) Continuation-in-part of application No. 10/634,342, filed on Aug. 5, 2003.
Application No. 10/634,342 is a continuation of application No. 09/343,920, filed on Jun. 30, 1999, now Pat. No. 6,633,384.
(63) Continuation-in-part of application No. 10/668,896, filed on Sep. 23, 2003.
Application No. 10/668,896 is a continuation of application No. 09/416,399, filed on Oct. 12, 1999, now Pat. No. 6,657,733.
Application No. 09/416,399 is a continuation-in-part of application No. 09/345,558, filed on Jun. 30, 1999, now Pat. No. 6,122,060.
(60) Provisional application No. 60/218,340, filed on Jul. 14, 2000.
(60) Provisional application No. 60/091,240, filed on Jun. 30, 1998.
(60) Provisional application No. 60/091,229, filed on Jun. 30, 1998.

(51) Int. Cl. G01N 29/10; G01N 29/26; G01N 21/88; G01N 23/20; G01B 11/30

(52) U.S. Cl. 73/621; 73/601; 73/602; 73/866.5; 702/36; 356/398

(57) ABSTRACT

The invention is directed to an ultrasonic testing system. The system tests a manufactured part for various physical attributes, including specific flaws, defects, or composition of materials. The part can be housed in a gantry system that holds the part stable. An energy generator illuminates the part with energy and the part emanates energy from that illumination. Based on the emanations from the part, the system can determined precisely where the part is in free space. The energy illumination device and the receptor have a predetermined relationship in free space. This means the location of the illumination mechanism and the reception mechanism is known. Additionally, the coordinates of the actual testing device also have a predetermined relationship to the illumination device, the reception device, or both.

### RELATED APPLICATIONS

The present application is a continuation-in-part of U.S. application Ser. No. 10/645,404 filed Aug. 21, 2003, which is a continuation of U.S. application Ser. No. 09/907,493 filed Jul. 16, 2001 (now U.S. Pat. No. 6,643,002 issued Nov. 4, 2003), which claims the benefit of U.S. Provisional Application No. 60/218,340 filed Jul. 14, 2000, all of which are hereby incorporated herein by reference.

The present application is also a continuation-in-part of U.S. application Ser. No. 10/634,342 filed Aug. 5, 2003, which is a continuation of U.S. application Ser. No. 09/343,920 filed Jun. 30, 1999 (now U.S. Pat. No. 6,633,384 issued Oct. 14, 2003), which claims priority to U.S. Provisional Application No. 60/091,240 filed Jun. 30, 1998, all of which are hereby incorporated herein by reference.

The present application is also a continuation-in-part of U.S. application Ser. No. 10/668,896 filed Sep. 23, 2003, which is a continuation of U.S. application Ser. No. 09/416,399 filed Oct. 12, 1999 (now U.S. Pat. No. 6,657,733 issued Dec. 2, 2003), which is a continuation-in-part of U.S. application Ser. No. 09/345,558 filed Jun. 30, 1999 (now U.S. Pat. No. 6,122,060 issued Sep. 19, 2000), which claims priority to U.S. Provisional Application No. 60/091,229, filed Jun. 30, 1998, all of which are hereby incorporated herein by reference.

### TECHNICAL FIELD OF THE INVENTION

The present invention relates generally to a system and method for locating and positioning an ultrasonic signal generator with respect to a tested part. In particular, the invention is directed to a system and method for delivering a laser beam generated by a laser source to a particular point on a tested object, or for determining a precise point on the object the ultrasonic signal generator delivered the energy to, in a gantry positioning system for use in detecting material defects of a test object using ultrasonic techniques.

### BACKGROUND INFORMATION

It is desirable for a variety of applications to provide for mechanically directing a laser beam to any location within a predetermined volume. Many of these applications are tailored specifically for use within industrial manufacturing applications employing automated robotics systems. Over the past several decades, the advent of robotics and laser light source technologies have led to many integrated systems for assembly line manufacturing. For example, robotics assembly systems incorporating laser technologies are very typical in automobile and even aircraft manufacturing plants for performing such tasks as welding.

For many systems, a robotic or gantry positioning system having a mechanical armature is often used to direct a laser beam to a variety of locations of a single workpiece. This armature itself provides for precision directing of the laser beam from the end of the mechanical armature. A laser beam delivery system is normally integrated into the gantry positioning system (GPS), particularly into the mechanical armature, for directing the laser beam from the end 0=the mechanical armature to any location within a predetermined volume. Specifically, the laser beam is then directed to portions of a workpiece and often from various fields of view for welding, cutting, ablating, or any variety of applications employing a laser beam. While the concept of incorporating a laser beam delivery system into a mechanical armature system for delivering to a workpiece is known to those skilled in the art, the methods and manners for accomplishing this goal may be very diverse.

Various technologies employ a method or system for directing a laser beam through a robotics system, e.g.

U.S. Pat. No. 4,661,680 “End-of-arm tooling carousel apparatus for use with a robot” by R. L. Swensrud; U.S. Pat. No. 4,659,902 “Robot laser system” by R. L. Swensrud et al.; U.S. Pat. No. 4,539,462 “Robotic laser beam delivery apparatus” by D. J. Plankenhorn. These technologies generally employ a plurality of tubular members, optically coupled to one another, through which a laser beam passes for directing the laser beam from the end of a GPS or “orthogonal axis manipulator system” (See Swensrud U.S. Pat. No. 4,659,902). These optical components for directing the laser beam through the laser beam delivery system may include spherical joint lenses or precision aligned mirrors at the pivotal connections of the armature of the GPS.

For GPSs that are relatively small in size and whose mechanical armature is light in weight, the directing of the laser beam through the armature may be provided by using a number of mirrors that are permanently located in fixed positions at the junctures of the mechanical armature. However, larger GPSs may include large carriage assemblies common to industrial workshops and other similar settings. The mechanical members of the GPS may bend and stress significantly depending on the position of the carriage assembly and the shape of the mechanical armature. These bends and stresses may result in laser beam steering within the segments of the GPS and ultimately may result in obstruction of the laser beam altogether. This stems from the fact that the mirrors are firmly attached to the mechanical armature of the GPS, and as the shape of the GPS bends, the mirrors may come out of alignment. A common solution for this problem in those laser beam delivery systems that employ air cavity propagation of the laser beam in enclosed segments along the axes of the GPS is to require significantly large dimensioned enclosed segments to accommodate the substantial bending associated with a large GPS while maintaining a large working envelope. Additionally, larger mirrors may be required to accommodate and correct for this beam steering to ensure unobstructed transmission of the laser beam. This requirement may substantially increase the size of the laser beam delivery system within the GPS. This may also increase the cost for materials required for the laser beam delivery system as well as further complicate the integration of the laser beam delivery system into the GPS given its larger bulk.

Small GPSs may not suffer from such problems as severe bending and stresses given their relatively small size, yet the intrinsic different needs of various sized GPSs makes utilizing a single laser beam delivery system in variety of different sized GPSs extremely difficult. GPSs which are relatively small in size and light in weight do not require large members and mirrors through which a laser beam propagates; large GPSs require either a large working enveloped through which the laser beam travels or some additional modification to accommodate the bending of the mechanical armature of the GPS to maintain unobstructed laser beam propagation. However, some lasers suffer from beam pointing instabilities. This requires corrective alignment procedures to maintain long-term operation when employing long distance free space beam delivery methods. An approach for providing laser beam delivery through a gantry positioning system that is scaleable and adaptable to a variety of sizes and shapes of GPSs irrespective of the overall size and weight of the armatures of the GPS is desirable.

While a large GPS may comprise a laser beam delivery system with large members through which a laser beam propagates to overcome the problems of beam obstruction resulting from bending and stressing of the GPS as it changes shape, as described above, many problems remain in that the laser beam delivery system must be designed specifically for the GPS in question. The larger the size and heavier the weight of the GPS, the more beam steering may occur resulting in possible beam obstruction requiring larger members and mirrors to ensure unobstructed beam transmission. Such a solution to beam obstruction requires the size of the members through which a laser beam propagates be tailored specifically to the size, weight, and operating constraints of GPS in question.

Ultrasonic testing is a method which may be used to detect material defects in objects comprised of various materials. A common application for ultrasonic testing is to detect inhomogeneities in composite materials. Ultrasonic testing may be used to serve a variety of industrial needs including identification of defects in manufactured goods for tuning of manufacturing processes. Manufacturers of products comprising composite material may wish to identify imperfections in their articles of manufacture to modify their manufacturing process to strive for greater repeatability and efficiency in their process or simply to identity problem areas within their process. Composite materials comprise many critical components within modern, high performance aircraft, and are becoming more common in terrestrial applications such as the automotive industry. Composite materials are desirable for many of their inherent attributes including light weight, high strength, and stiffness. Particularly for aircraft application, those composite material components, which may be large and complex in shape, are often flight critical necessitating strict assurance of material and structural integrity.

Unfortunately, these materials are sometimes fabricated with imperfections or develop them after several hours of use. These material defects may appear as a delamination of the surface of the material, porosity, an inclusion, debonds between bonded sub-components, or a void within the component itself. This inhomogeneity in the structure severely weakens it, providing a situation which might result in catastrophic failure. A conventional method for detecting material defects in a composite material utilizes piezoelectric transducers in conjunction with mechanical scanners mounted across the surface of the composite to detect any material imperfections. The disadvantages of the conventional methods are many, including difficulty in accommodating non-flat or evenly mildly contoured composite materials. Another disadvantage is the requirement that the transducer couple to the material via a water path. The transducer must remain normal to the surface within +/−3° during a scan. To accommodate highly-contoured and complex shaped components using conventional techniques often requires extremely time-intensive test set up preparation.

Laser ultrasonic testing is an alternative method that is used to identify these imperfections. For aircraft applications, particularly for military fighter aircraft, all flight critical parts fabricated of composite material must be fully inspected before installation. A GPS comprising a laser beam delivery system may be integrated with a laser ultrasonic testing system for providing automated identification of material defects of a test object.

One approach is to mount the laser ultrasonic testing system comprising a laser source on the end of the mechanical armature of the GPS. The use of a GPS allows the ultrasonic testing system to be maneuvered around the test object to provide for positioning the laser source in close proximity to the test object from a multitude of locations of fields of vision. For those ultrasonic testing systems which use high power gas lasers such as CO2 lasers, the large and bulky size of the laser complicates the integration of the ultrasonic testing system with the GPS as the end segment of the mechanical armature must be capable of supporting a significantly heavy weight at its end. The large size and bulky weight of the light source itself often demands the use of a very large GPS capable of supporting the heavy weight of an ultrasonic testing system as it is maneuvered around the test object to perform data acquisition from a variety of perspectives.

Many typical laser testing systems are hampered when the ultrasonic energy generator is not positioned properly relative to the part to be tested. When this happens, the test results may need to be corrected, or in the case of testing relative strengths of different parts, this test may be completely inconclusive. Further, when the ultrasonic signal is generated, the resulting ultrasonic signal affects certain areas and/or volumes of the tested object. To completely test an object requires that a signal ultrasonic event be generated many times throughout various places on the surface and interior to the object. By doing this numerous times, the complete object may be tested, even though some areas affected may be common to others. In this case, many systems that rely on manual positioning err on a conservative side. This results in hugely overcompensated testing of the part since the overlaps are huge. Precise positioning of the ultrasonic testing device allows for scalable and efficient economies in the testing process, since the area of overlaps may be minimized.

### SUMMARY OF THE INVENTION

The present invention utilizes a robotic or gantry positioning system (GPS) with an integral laser beam delivery system for delivering a laser beam from a remote laser source to a test object for detecting material defects using a laser ultrasonic testing system. The gantry positioning system may have the form of any variety of positioning systems commonly known to those skilled in the art. A typical configuration will generally include a mechanical armature that allows for the placement of its end to any location within a desired work space. This armature commonly includes a number of straight segments connected at each end and is operated using a number of actuators which provide for the moving and directing of the armature throughout the work space for some desirable or useful purpose. This GPS may take the form of a relatively small robotic-type armature; it may take the form of a system resembling an industrial crane common to machine shops and other industrial facilities; it may take the form of any number of configurations of various sizes and weights which provide for the movement of the end of a mechanical armature throughout the entirety of a defined work space.

The present invention includes a laser beam delivery system which is integrated into the GPS for transmitting a laser beam along the axes of motion of the GPS while its mechanical armature is in operation. The axes of motion of the GPS often correspond to the gantry members of the mechanical armature which combine to form the GPS; the gantry members are often connected in some pivotal manner to allow for freedom of movement in multiple directions. The laser beam is delivered through the entire GPS to a test object for performing ultrasonic testing on the test object. Each of the gantry members of the mechanical armature of the GPS comprises an optical transmission channel to guide the laser beam after being injected into the first gantry member of the GPS.

Additionally, the present invention provides a number of alignment fixtures within these optical transmission channels and a position feedback sensor to detect whether or not the laser beam is transmitting through the entire GPS free from obstruction. This position feedback sensor emits an alignment signal indicating whether or not the laser beam is transmitting fully through the alignment fixtures. The GPS allows the laser beam to be directed from the end segment of the mechanical armature at the test object from multiple points of view, thereby providing ultrasonic testing from all encompassing perspectives of the test object. For complete analysis of the test object, the GPS provides for ultrasonic testing of the object from a first field of view, then normally from several additional fields of view. Data from each of these fields of view is then utilized for detecting any material defects of the test object using ultrasonic techniques.

When using laser ultrasonic techniques, it is desirable to use a laser source of high output power to provide sufficient heat and excitation of the material of the test object. A typical laser source for use in ultrasonic testing is a carbon dioxide gas laser (CO2 gas laser). However, those skilled in the art will recognize a number of other lasers may also be used. A number of mirrors also assist to direct and guide the laser beam from the optical transmission channels of the various gantry members of the GPS. At least one mirror is located at the each of the connection points of the mechanical armature of the GPS to guide it from the optical transmission channels of adjacent gantry members. The angular alignment mirrors in the present invention is controlled by a number of mirror actuators which adjust the angular alignment of the mirrors in response to the alignment signals from the above-mentioned position feedback sensors. If the laser beam has somehow become obstructed and no longer transmits through the GPS, the mirror actuators change the angular alignment of the mirrors to re-align the path of the laser beam until transmission is re-established. Such a system and method provides for closed-loop error correction in real time to ensure transmission of the laser beam through the entire GPS.

Laser beam divergence is an additional problem that may occur in a system which provides for the directing of a laser beam, particularly where the medium of the system is air. For the present invention, a laser beam conditioning system comprises part of the laser beam delivery system for minimizing the divergence of the laser beam as it propagates through the GPS as well as providing for the conditioning of the beam to maintain certain properties after the laser beam has exited the GPS. Laser light diverges as it propagates due to its intrinsic Gaussian nature. Those skilled in the art recognize many different methods of minimizing the Gaussian beam divergence of a free space propagating laser beam.

A very common approach is to position a lens, or a sequence of lenses at predetermined locations along the propagation path of the laser beam to reshape the beam as it propagates to maintain the desired properties of the beam along the entire propagation path. For example, in the present invention, lenses could be placed along the optical transmission channels of the gantry segments at various locations that are calculated to maintain the same properties of the laser beam at entrance and exit of the GPS. The lenses may also be located near the mirrors which guide the laser beam from the optical transmission channels of the various gantry members of the GPS. Bulk optical lenses are not the only components of which the laser beam conditioning system provides may be comprised. Those skilled in the art can readily envision a number of additional components which may be used to minimize divergence of a propagating beam, such a various apertures, gratings, crystals, etc., which may all cooperate to minimize the divergence of the laser beam as it propagates through the GPS. Laser beam divergence may also present a problem after the laser beam has exited the end gantry member. The user of the present invention may wish to focus the laser beam on a specific location of the test object. A laser beam conditioning system provides the user with great flexibility to control various laser beam properties during transmission through the GPS as well as after the beam has left the GPS entirely.

The present invention employs a laser ultrasonic testing system which is used to identify and detect material defects in a test object. Data is acquired of the test object and is analyzed for identifying any material defects in the test object and for providing the precise locations of them. Identifying material defects in composite materials, particularly those within aircraft applications, may provide aircraft designers with information concerning actual life and fatigue of flight critical, composite components as well as provide manufacturers of composite components with information concerning stress and failure points of the component. The ultrasonic testing system within this invention is provided and presented in detail in U.S. patent application Ser. No. 09/343,920 entitled “System and Method for Laser Ultrasonic Testing” by T. E. Drake, Jr.

The present invention provides an important technical advantage by providing a laser beam delivery system which is scaleable and adaptable to a variety of gantry positioning systems (GPSs) of varying sizes and weight by providing closed-loop error correction of the transmission of a laser beam provided by a remote laser source through a GPS.

The present invention provides another technical advantage by providing for automated data acquisition of a test object by moving the end gantry member of a GPS around the test object in between various acquisitions of data thereby providing multiple fields of view of the test object for ultrasonic testing purposes.

The present invention provides another technical advantage by providing for focusing of the laser beam by using a laser beam conditioning system. This laser beam conditioning system permits the user of the present invention to control various properties of the laser beam that is used for ultrasonic testing purposes.

Aspects of the invention are found in an ultrasonic lasing system. The laser system tests a manufactured part for various physical attributes, including specific flaws, defects, or composition of materials. The part can be housed in a gantry system that holds the part stable. An energy generator illuminates the part within energy and the part emanates energy from that illumination. Based on the emanations from the part, the system can determine precisely where the part is in free space. The energy illumination device and the receptor have a predetermined relationship in free space. This means the location of the illumination mechanism and the reception mechanism is known. Additionally, the coordinates of the actual testing device also have a predetermined relationship to the illumination device, the reception device, or both. Thus, when one fixes the points in free space where the part is relative to either of the illumination device or the reception device, one can fix the point and/or orientation of the testing device to that part as well.

It should be noted that the results of the point and/or orientation detection may also be used in an actuator and control system. If the position of the testing device needs to be altered with respect to the tested object, the control system and actuator may use the results of this determination to move the testing device relative to the tested object. To do this, either the tested object needs to be moved within the gantry system, or the testing device needs to be moved relative to the tested object. Of course, these actions may occur in combination. This may be accomplished with a computer that assists in determining the position and/or orientation. This may be used to control the relative movement of the object and testing device.

The system may also be used not only to precisely position a testing device relative to an object, but may be used for compensation purposes as well. In this embodiment, the testing system tests the object, then the positioning system determines the relative position of the object to the position and/or orientation of the testing device. When the position and/or orientation of the testing device relative to the tested object is not exact, a CAD representation of the object may be used to derive corrections based on incorrect orientation and/or positioning aspects of the system.

The generating energy may be of various sorts. This includes electromagnetic as well as sonic. In the case of an electromagnetic system, various forms of this energy may be used as well. For example, the generator may generate radar waves and the receptor may detect these reflected radar waves. Or, the generator may generator coherent energy, such as a laser, that bathes the object. The reception apparatus may be a camera or other optical receiver such as a photoelectric detector. In this case, the various lightings, and optical characteristics of the light receptor, such as focal point of the receptor, allow one to determine the spatial orientation of the generating device and the receiving device in space relative to the object. Or, another energy, such as sonic energy, may be used in a sonar-type system.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 illustrates the use of a generation laser beam and a detection laser beam coaxial therewith;

FIG. 2 is a block diagram showing the basic components of an apparatus for performing ultrasonic laser testing;

FIG. 3 presents a large aperture optical scanner;

FIG. 4 presents a small aperture optical scanner;

FIGS. 5A-C show examples of a gantry mounted test apparatus with an internal calibration unit;

FIG. 6 shows a laser guiding configuration for transmitting a laser beam through two alignment apertures;

FIG. 7 shows the mirror adjusting algorithm for transmitting a laser beam through two alignment apertures used by the configuration of FIG. 6;

FIG. 8 shows one embodiment of a gantry positioning and ultrasonic testing system with an integral laser beam delivery system;

FIGS. 9A-B show a particular embodiment of FIG. 8 of gantry positioning and ultrasonic testing system with an integral laser beam delivery system;

FIGS. 10A-F depict various scan of parts and their results;

FIGS. 11A-F depict various scan of parts and their results;

FIGS. 12A-F depict various scan of parts and their results;

FIGS. 13A-F depict various scan of parts and their results;

FIG. 14 depicts a flow chart illustrating the method of the present invention.

FIG. 15 is a diagram showing the operational units of an embodiment of the invention.

FIG. 16 is a diagram of a specific embodiment of the system of FIG. 15.

FIG. 17 is a diagram detailing the use of the system of FIG. 15 with a multi-axis laser positioning system;

FIG. 18 is a diagram detailing the potential relationships inherent in the system of FIG. 15;

FIG. 19 is a diagram detailing the potential relationships inherent in the system of FIG. 15;

FIGS. 20A-F is a diagram detailing a process of how the system of FIG. 15 can operate.

### DETAILED DESCRIPTION OF THE INVENTION

Preferred embodiments of the present invention are illustrated in the FIGUREs, like numerals being used to refer to like and corresponding parts of the various drawings.

The present invention employs a gantry positioning system with an integral laser beam delivery system for delivering a laser beam delivered by a remote laser source to a test object for performing ultrasonic testing to detect any material defects in the test object. The gantry positioning system provides for scanning the entire test object from various fields of view to map out the test object using laser ultrasonic techniques. Data are recorded from all of the fields of view and later processed to provide for not only the detection of any such material defects, but also their location within the test object.

FIG. 1 illustrates an incoming laser beam which represents a generation laser beam 111 and a coaxial detection laser beam 121 upon a remote target 150. Generation laser beam 111 causes thermo-elastic expansion in the target 150 in the form of ultrasonic surface deformations, which deformations modulate, scatter and reflect detection laser beam 121, represented by the phase-modulated light 131 directed away from target 150.

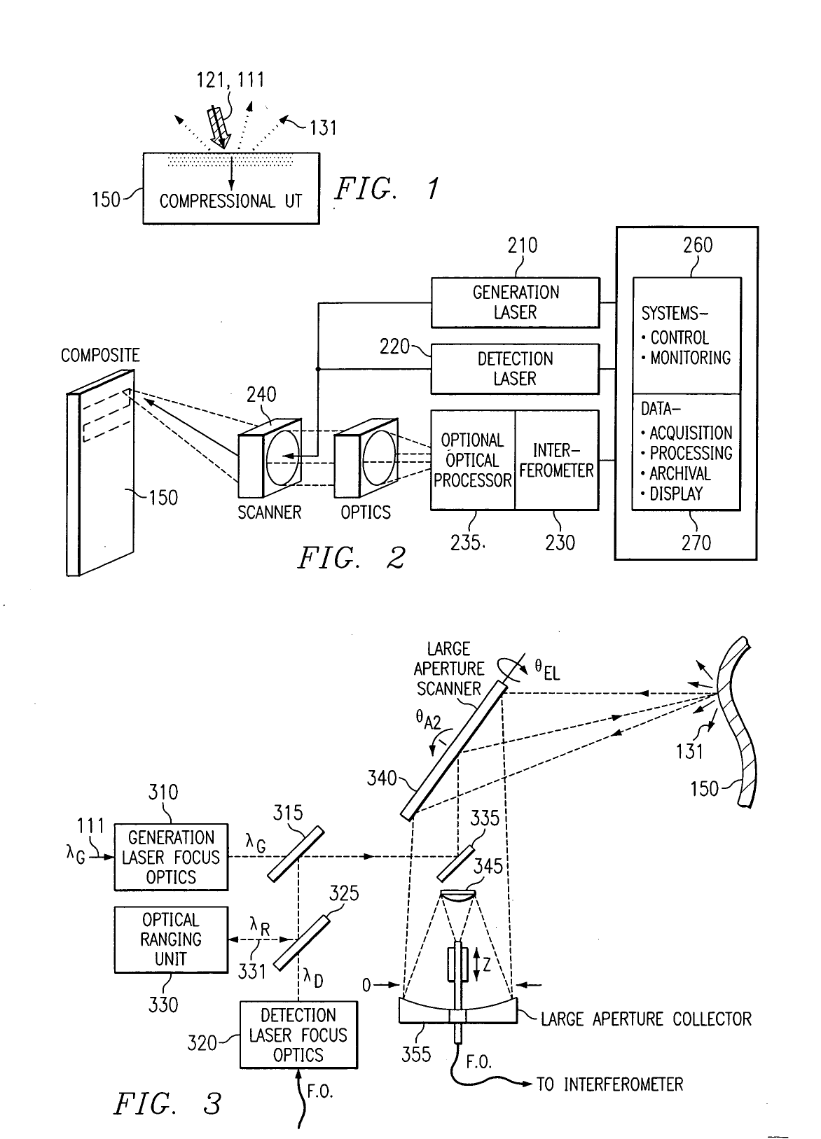

FIG. 2 illustrates in block diagram form the basic components of an apparatus 200 for performing ultrasonic laser testing. Apparatus 200 comprises a generation laser 210, a detection laser 220, an interferometer 230, an optional optical processor 235, an optical scanner 240, collection optics 250, systems controller 260, and data acquisition and processing apparatus 270. Generation laser 210 and detection laser 220 generate a generation laser beam 111 and a detection laser beam 121, respectively, which are directed by optical scanner 240 upon a target 150, which is typically a composite material. The generation laser 210 produces a compressional ultrasonic wave in the material normal to the surface of the target 150. The compressional ultrasonic wave is the result of thermo-elastic expansion of the composite material as it absorbs generation laser beam 111.

The generation laser 210 must be of a frequency that is readily absorbed into the surface of target 150 without causing ablation or breaking down the target material, and it must be of the appropriate pulse duration to induce ultrasonic surface deformations. For example, a transverse-excited atmospheric (TEA) CO₂ laser can be used to produce a 10.6 micron wavelength beam for a 100 nanosecond pulse. The power of the laser must be sufficient to deliver, for example, a 0.25 joule pulse to the target, which may require a 100 watt laser operating at a 400 Hz pulse repetition rate. The generation laser should be absorbed as heat into the target surface thereby causing thermo-elastic expansion without ablation. Generally, utilizing a wavelength in the ultraviolet range is undesirable because such light can potentially damage the composite material.

The detection laser 220 must be of sufficient pulse duration to not induce ultrasonic surface displacements. For example, a Nd:YAG laser can be used. The power of this laser must be sufficient to deliver, for example, a 100 milli-joule, 100 micro-second pulse, which may require a one kilo-watt laser.

FIG. 3 illustrates a large aperture optical scanning configuration with an integrated distance ranging unit. Generation laser beam 111 is focused by generation laser focus optics 310 through a first optical lens assembly 315 which is transmissive to generation laser beam 111. Reflective surface 335 then directs generation laser beam 111 upon large aperture scanner 340 which, in turn, directs said beam 111 upon a surface of target 150, which induces an ultrasonic wave therein.

As shown in FIG. 3, detection laser beam 121 is directed by fiber optics into detection laser focus optics 320, which focuses laser beam 121 through a second optical lens 325 which is transmissive to detection laser beam 121. Detection laser beam 121 is reflected off first optical lens 315 and emerges coaxial with generation laser beam 111. First optical assembly 315 and second optical assembly 325 act collectively to form a beam combiner or beam mixer. Detection laser beam 121 is then reflected along with generation laser beam 111 upon a turning mirror or a reflective surface 335, which then directs detection laser beam 121 upon large aperture scanner 340 which, in turn, directs said beam 121 upon the surface of target 150. Detection laser beam 121 interacts with the ultrasonic waves present in the surface of target 150, and is reflected as phase modulated light 131. Some of the phase modulated light is captured by large aperture scanner 340 and is directed upon large aperture collector 350. Large aperture scanner 340 is generally of the single-mirror two-axis gimbal construction with each axis driven via a motor and gear assembly. Large aperture collector 350 may be of a Cassegrian-type reflective optic, comprised of a primary reflective surface 355 which focuses light upon a secondary reflective surface 345, which in turn, collects the light and focuses it into a fiber optic carrier.

FIG. 3 also illustrates the integrated optical ranging unit 330 which directs a ranging laser beam 331 upon optical lens 325 which reflects said laser beam 331 upon first optical lens 315. Ranging laser beam 331 emerges coaxial with generation laser beam 111 and detection laser beam 121. Ranging laser beam 331 is then reflected along the same path as detection laser beam 121 and also is reflected from the surface of target 150. Some of the reflected ranging laser is captured by large aperture scanner 340 and directed backwards upon the same path which it traveled to reach target 150. Scanner 340, collection optics 345 and 355 are generally defined as of the large aperture type for beam clear apertures larger than approximately 75 mm for distances to the target in the 1000 mm to 4000 mm range. Optical ranging unit 330 is able to determine from the reflected light the distance between the surface of the target 150 being illuminated and the scanning apparatus. Because optical ranging unit 330 both transmits and receives light of the same frequency, it is described as a self-contained ranging apparatus. It is important to know the distance by which the surface being illuminated is located from the scanner so that a topographical contour can be created for target 150 and correlated to the optical data being collected. Generally, this correlation is recorded on a point-by-point basis.

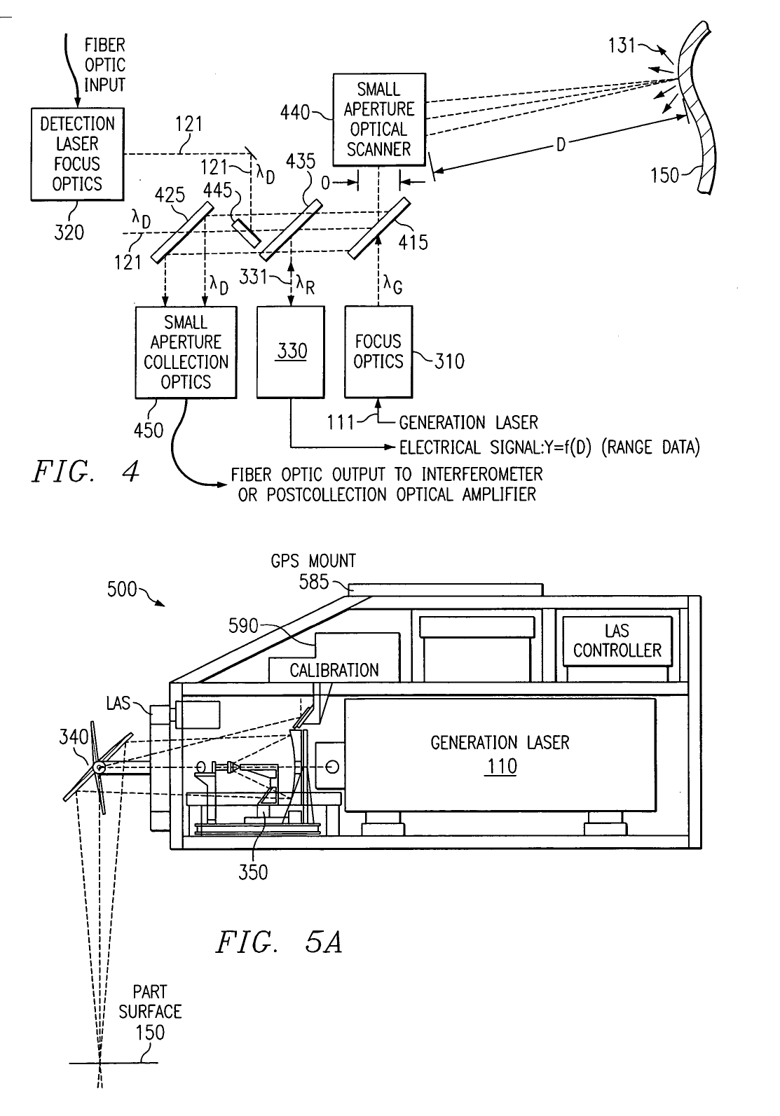

FIG. 4 illustrates a small aperture optical scanning configuration with an integrated distance ranging unit. Small aperture is generally defined, in this application, for clear apertures less than 75 mm, for target distances between 1000 mm and 4000 mm. The operation of the small aperture configuration is similar to that of the large aperture optical scanning configuration previously discussed with a slight rearrangement of the optical elements to accommodate the laser beams through the smaller apertures. Generation laser beam 111 is focused by generation laser focus optics 310 through a first optical element 415 to small aperture scanner 440, where in the optical element 415 is transmissive to generation laser beam 111. Small aperture scanner 440, in turn, directs said beam 111 upon a surface of target 150, which induces an ultrasonic wave therein. Small aperture scanner 440 is generally of two-mirror construction with each mirror mounted on orthogonal oriented high-speed galvanometers.

As shown in FIG. 4, detection laser beam 121 is directed by fiber optics into detection laser focus optics 320, which directs laser beam 121 to a small reflective turning mirror 445 and through optical element 435, which is transmissive to detection laser beam 121. Detection laser beam 121 is reflected off first optical element 415 and emerges coaxial with generation laser beam 111. Reflective turning mirror 455 is generally of elliptical profile so as to produce a small circular diameter exactly matching detection laser beam 121 when operated at 45 degrees angle of incidence, and thereby obscuring a minimal amount of collection optic 450. First optical element 415, second optical element 425, and third optical element 435 collectively act to form a beam combiner or beam mixer. Detection laser beam 121 is then reflected along with generation laser beam 111 upon small aperture scanner 440 which, in turn, directs said beam 121 upon the surface of target 150. Detection laser beam 121 interacts with the ultrasonic waves present in the surface of target 150, and is reflected as phase-modulated light 131. Some of phase modulated light 131 is captured by small aperture scanner 440 and is reflected off first optical element 415, through third optical element 435, and reflected off second optical element 425 into small aperture collector 450. Optical element 445 will, by proper design, obscure a minimal portion of the light captured by scanner 440.

FIG. 4 also illustrates the integrated optical ranging unit 330 which directs a ranging laser beam 331 upon third optical element 435 which reflects laser beam 331 upon first optical element 415. Ranging laser beam 331 emerges coaxial with generation laser beam 111 and detection laser beam 121. Ranging laser beam 331 is then reflected along the same path as detection laser beam 121 and also gets reflected from the surface of target 150. Some of the reflected ranging laser is captured by small aperture scanner 440 and directed backwards upon the same path which it traveled to reach target 150. Optical ranging unit 330 is able to determine from the reflected light the distance between the scanning apparatus and the surface of the target 150 being illuminated. The distance between the scanning apparatus and the surface being illuminated is used to create a topographical contour of the target 150 being scanned, and is correlated to the optical data being collected. Generally, this correlation is recorded on a point-by-point basis.

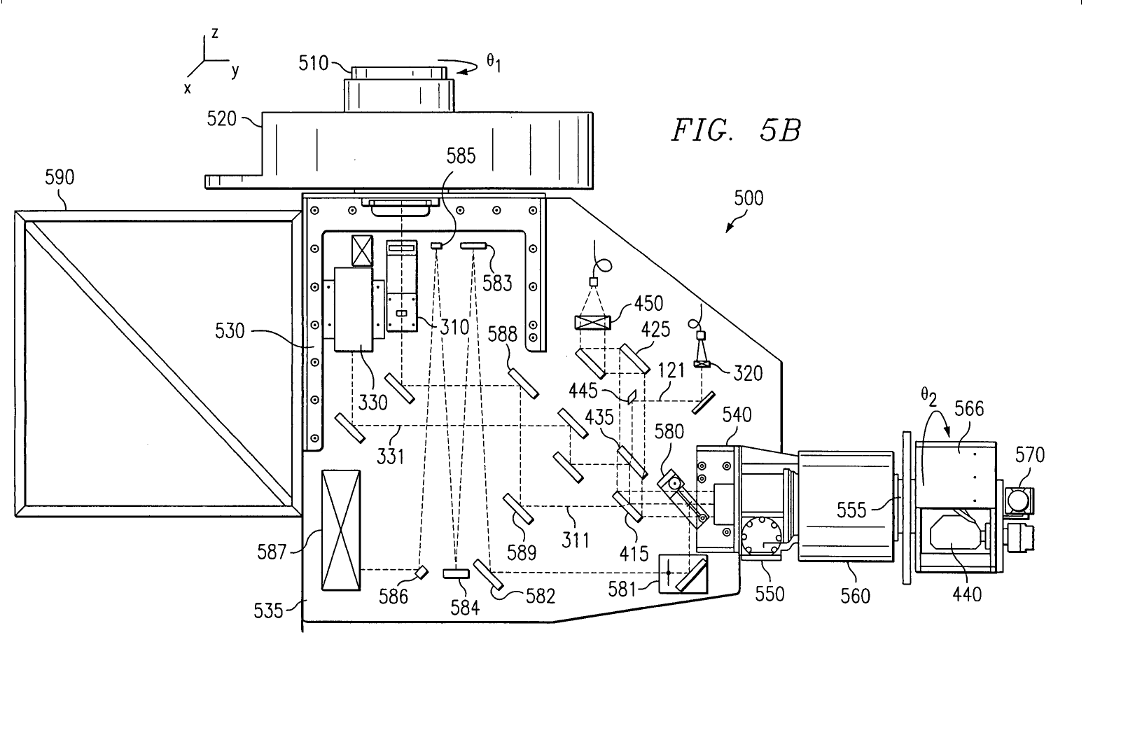

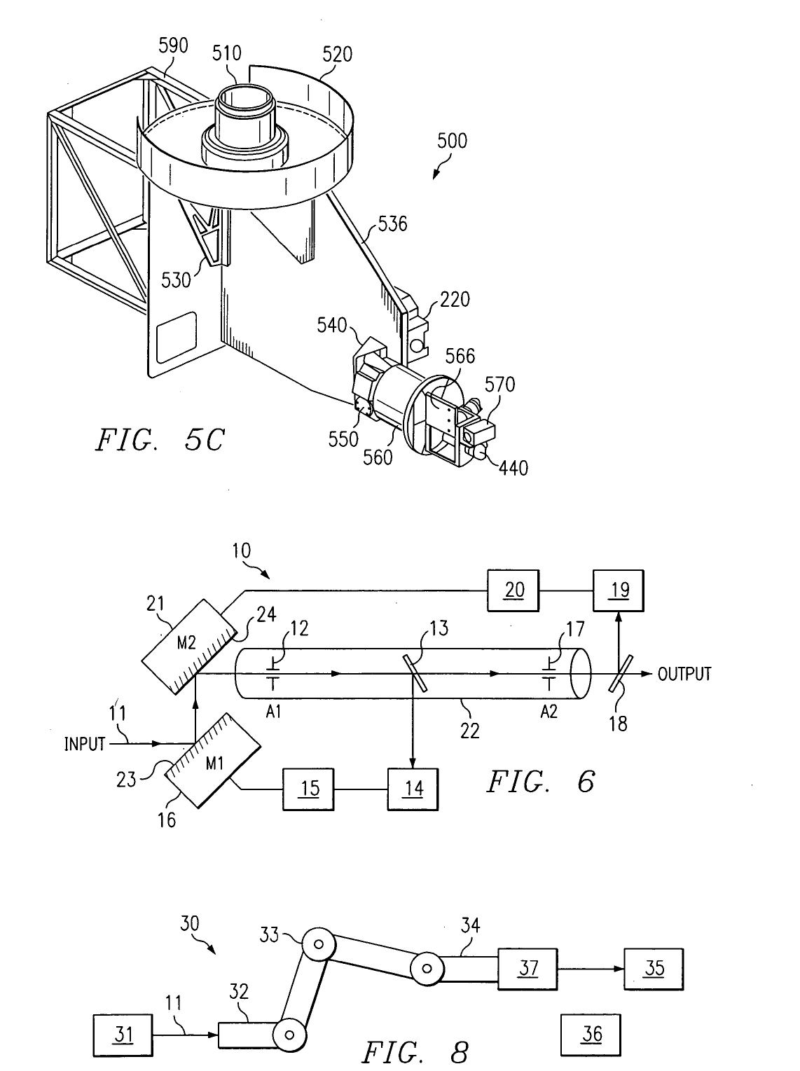

FIGS. 5A-5C illustrate examples of a gantry mounted laser scanning and test apparatus 500 with an internal calibration unit 590. In FIG. 5A, large aperture scanner 340 is used to reflect generation laser beam 111 and detection laser beam 121 upon reflective surface 595 and into calibration unit 590. Calibration unit 590 will determine whether the two said laser beams are coaxial, and communicate with the laser scanning apparatus 550 to make adjustments if they are not coaxial. In this configuration, laser scanning and test apparatus 500 is mounted to a gantry positioning apparatus (“GPS”) using GPS mounts 585, which mounts permit the entire laser scanning and test apparatus 500 to move significant distances, for example, to permit adjustments as would be necessary along a production line.

FIG. 5B illustrates a portion of an example laser scanning and test apparatus 500, referred to as “scan head 500”, that is typically, although not exclusively, mounted to a gantry positioning system (GPS) capable of indexing said apparatus throughout a Cartesian work volume defined by {x, y, z}. Generation laser 110 may be remotely located on the GPS, or alternatively ground mounted and directed along the x and y axis, and eventually directed concentric with the z-mast assembly through gantry mounting ring 510. Another embodiment of said invention would allow delivery of generation laser 210 laser beam 111 through an optical fiber. Fiber optic delivery of laser beam 111 would allow generation laser 210 to be remotely located or optionally mounted within scan head 500. Scan head 500 can be rotated concentric to the z-axis defined as theta-1 to reposition the orientation of the optical table mounting bracket 530 and optical table 535. Cable tray 520 provides electrical, optical, and other connections to 500 allowing 360-degree rotation of theta-1. Bracket 540 attaches motor 550 to optical table 535. Motor 550 rotates optical scanner 440 via torque tube 555 concentric with the optical axis, defined as the theta-2 axis. Slip ring 560 provides electrical connections between VME chassis 590 and components mounted to the theta-2 axis, including optical scanner 440, scanner shutter 565, and remote video camera 570. Scanner shutter 560 protects optical scanner 440 from dust contamination when not in use. Remote video camera 570 provides the operator at a distant location a view nearly aligned with the center view of scanner 440. Detection laser light 121 is collected from a remote composite surface located some distance D from the small-aperture optical scanner 440 and is reflected by element 415, transmitted by element 435, and is minimally obscured by mirror 445. Next 121 is directed by mirror 425, and other turning mirrors, onto small-aperture collector 450, and subsequently coupled into the collection fiber optic. This collection fiber is typically coupled to a post-collection optical amplifier 235 (FIG. 2) prior to processing by interferometer 230.

Motorized mirror mount 580 provides a method to redirect the optical path for all of the laser beams beyond optical element 415 but prior to optical scanner 440. Said redirected beams follow a path along a series of reflective turning mirrors 581, 582, 583, 584, 585, and 586 to an internal far-field calibration module 587, the number of turning mirrors is only representative of the desired function, where the actual number could be more or less. Tuning mirror 581, for example, would have an integrated near field adjustable aperture to establish a permanent alignment position to be used in conjunction with the internal far-field calibration module 587. Far-field calibration module 587 is located a distance from optical element 415 to be representative of a typical distance to a target following the standard path through optical scanner 440. Internal far-field calibration and diagnostic module 587 may contain, as example, devices to monitor the power and alignment of each laser, small targets representative of typical testing materials, and devices to assist in the characterization of new materials over a variety of incident angles. As an example, information derived from the internal far-field calibration and diagnostic module 587 could be used to align the generation laser beam 111 to the desired optic axis via motorized reflective tuning mirrors 588 and 589. Such an operation may be necessary to correct for small beam delivery errors created by the remote free-space delivery of beam 111 along the movable axis {x, y, z, theta-1}. Other turning mirrors, not explicitly specified in FIG. 5B, may also incorporate motorized positioning features similar to 588 and 589 as required to allow a fully automated alignment and calibration procedure to be executed under computer control. All alignment procedures are generalized in that the motorized mirror nearest the far-field calibration module is adjusted for proper alignment, then the motorized mirror farthest from the near-field aperture is adjusted for alignment. This procedure is continued in an iterative manner until an allowable amount of positioning error is reached.

FIG. 5C illustrates an example scan head 500 in a perspective view with the addition of the detection laser mounted to the rear surface of optical table 535. In this configuration the detection laser beam 121 may be optionally fiber optic coupled to the front side of optical table 535 or directly coupled via turning mirrors. Fiber delivery via detection laser focusing optics 320 has the advantage of improved beam pointing stability due to the decoupling of any small beam pointing errors in laser 220. The peak power of laser 220 will limit the distance that fiber optics can be used to deliver beam 121 due to stimulated Brillouin scattering (SBS) effects. SBS threshold is dependent on the fiber diameter, fiber length, laser pulse duration, and laser peak power. For example, a Nd:YAG laser with a 100 microsecond pulse duration producing hundreds of watts of peak power would be limited to fiber lengths below 10 meters for 100 micron fiber diameters.

FIG. 6 shows a system 10 for providing closed loop feedback for directing a laser beam 11 through a first alignment aperture 12 and a second alignment aperture 17 contained within an optical transmission channel 22. A laser beam 11 is reflected off of a first dual axis. mirror 23 which provides for angular alignment and directing to a second dual axis mirror 24 for subsequent directing through the alignment apertures 12 and 17.

A beam splitter or diffractive sampling element 13 takes a portion of the laser beam and directs it to a detector 14 comprising an optical detector. An output signal from the position sensitive detector 14 is then fed to a logic circuit 15 which determines whether or not the laser beam 11 has passed through the first alignment aperture 12. If the laser beam 11 has not passed through the first alignment aperture 12, then a signal is sent from the logic circuit 15 to adjust to angular alignment of the first dual axis mirror 23 using a first mirror actuator 16. Such a system provides for closed-loop error correction of the laser beam through the GPS.

An analogous procedure is performed with respect to the second alignment aperture 17, except with the adjusting of the second dual axis mirror 24 using a second mirror actuator 21. A beam splitter 18 directs a portion of the laser beam 11 to a position sensitive detector 19, which then provides an output signal to a logic circuit 20 for providing closed-loop error correction of the second dual axis mirror 24 using a second mirror actuator 21. If detectors 14 and 19 are position sensitive detectors, then apertures 12 and 17 can be omitted and the error signal is derived from 14 and 19 only.

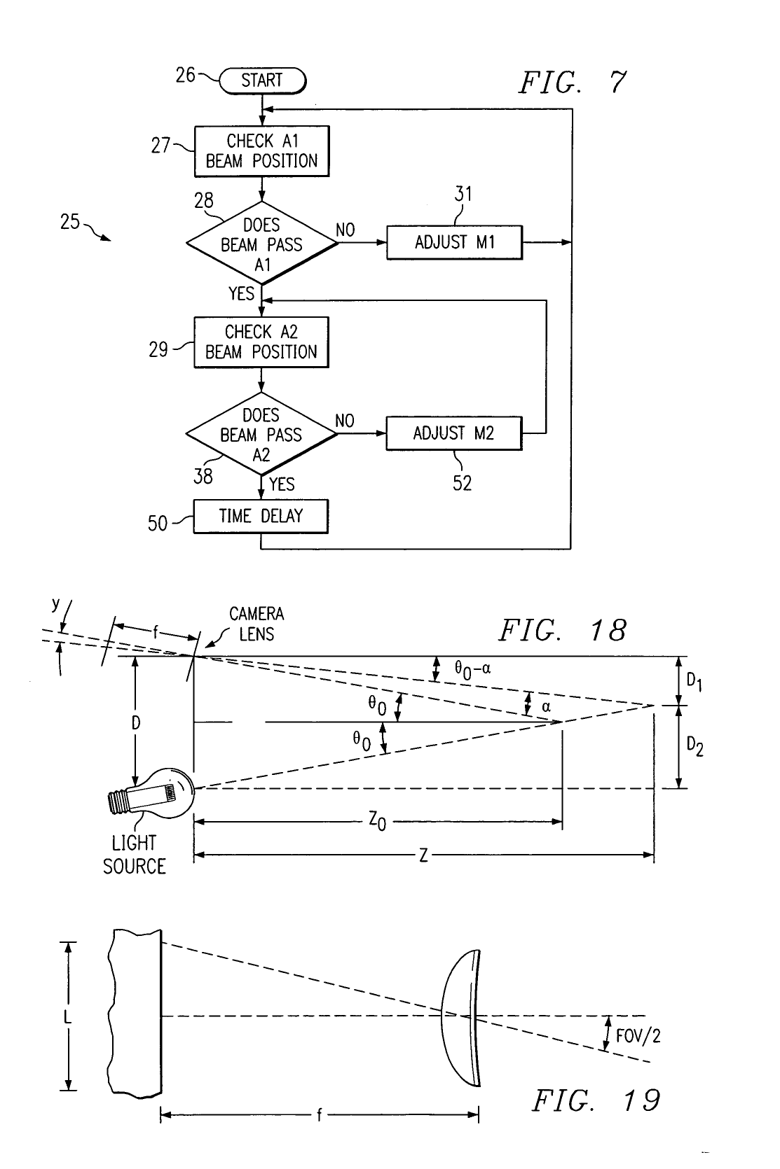

FIG. 7 shows the algorithm in flowchart format 25 which the system of FIG. 6 employs. In operation, the first step 26 shows the start of a measurement procedure. Step 27 depicts the next step of checking the A1 beam position. If, as step 28 tests, the laser beam passes point A1, a next check of the A2 beam position occurs at step 29. If the beam does not pass point A1, then mirror M1 is adjusted at step 31. Step 38 performs a test of whether the beam passes point A2. If so, process flow goes to time delay step 50 and then back to step 27 for checking the A1 beam position. If the laser beam does not pass A2, mirror M2 is adjusted at step 52 and process flow then goes to step 29 to, again, check the beam position at point A2.

FIG. 8 shows one embodiment 30 of a gantry positioning and ultrasonic testing system with an integral laser beam delivery system. A laser beam 11 is generated by a remote laser source 31 and inserted into the optical transmission channel of a first gantry member 32. Each gantry member of the gantry positioning system comprises an optical alignment system similar to that described in FIGS. 6 and 7 for guiding the laser beam 11 through the gantry positioning system and for delivering it to a test object 35 for performing ultrasonic testing. The gantry positioning system is comprised of a number of gantry members pivotally connected. At each of these pivotal connections is a gantry actuator 33 for controlling the shape of the gantry positioning system which provides for positioning the end gantry member 34 to any location within the desired workspace in which the test object 35 is located. By permitting the gantry positioning system to be manipulated around the workspace of the test object 35 allows for performing ultrasonic testing using an ultrasonic testing system 36 from a variety of fields of view. Additionally, a laser beam conditioning system 37 may be used to provide for minimizing the divergence of the laser beam 11 as it exits the end gantry member 34 of the gantry positioning system and is delivered to the test object 35. The laser beam conditioning system 37 could likewise be included within the optical transmission channels 22 of the gantry segments of the GPS to provide for conditioning and minimizing the divergence of the beam as it propagates through the GPS.

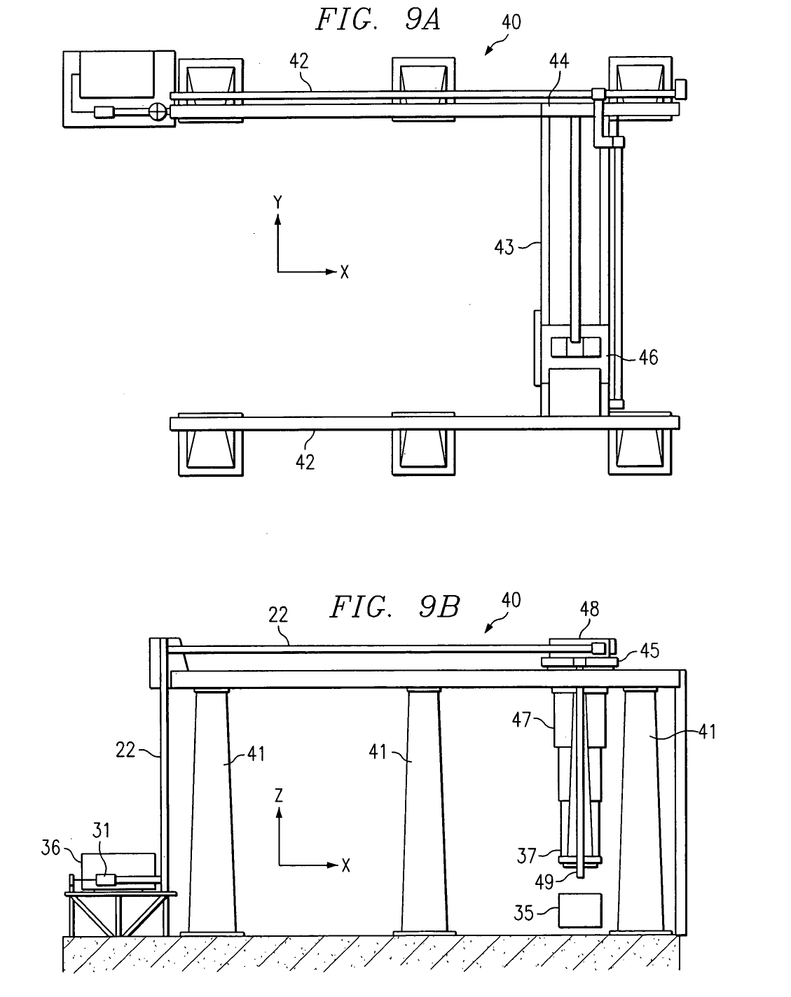

FIGS. 9A-B show a particular embodiment 40 of FIG. 8 of a gantry positioning and ultrasonic testing system with an integral laser beam delivery system. The gantry positioning system is comprised of a plurality of vertical support beams 41 which support two runway beams 42 which run parallel to one another. A bridge beam 43 spans between the two runway beams and is powered using a bridge beam actuator 44 for providing translation in a first direction, depicted as the X direction in the TOP VIEW shown in FIG. 9A. A carriage 45 is mounted on top of the bridge beam 43 and is powered using a carriage actuator 46 for providing translation in another direction which is orthogonal to the first direction. This second direction is depicted as the Y direction in the TOP VIEW shown in FIG. 9A. Extending downward from the bridge beam 43 is a Z-mast 47, whose length is variable and is controlled using a Z-mast actuator 48. The Z-mast provides for translation in a third direction, orthogonal to the first two directions. This third direction is depicted as the Z direction in the SIDE VIEW shown in FIG. 9B.

By providing movement in three orthogonal positions and delivering a laser beam throughout the system, the particular embodiment shown in FIGS. 9A-B of a gantry positioning system provides for emitting the laser beam 11 at any location within the workspace of the test object 35 allows for performing ultrasonic testing using an ultrasonic testing system from a variety of field of view, similarly to the capability shown in FIG. 8. Also in similar fashion to FIG. 8, a laser beam conditioning system 37 may be used to provide for minimizing the divergence of the laser beam 11 as it exits the end of the Z-mast 47 of this particular embodiment of a gantry positioning system and is delivered to the test object 35. The laser beam conditioning system 37 could likewise be included within the optical transmission channels 22 of the gantry segments of the GPS to provide for conditioning and minimizing the divergence of the beam as it propagates through the GPS. If even more spatial control is desired for directing the laser beam 11 from the end of the Z-mast 47, a rotation attachment platform 49 may be attached to the end of the Z-mast allowing additional directional control and delivering of the laser beam 11 to the test object 35.

The conventional method of incorporating a GPS with an ultrasonic testing system cannot provide for the interfacing of data acquisition of the test object after the laser beam has been delivered to it from a remote location, aside from mounting the entire ultrasonic testing system on the end segment of the mechanical armature wherein only the laser source is located remotely. To overcome the requirement of a large and robust GPS to be used for ultrasonic testing of a test object for identifying material defects, a system or method is required which will not only provide for the delivery of a laser beam from a remote laser source, but also perform data acquisition of the test object from a remote location. Though the art provides for the combination of a GPS with a laser beam delivery system for the delivery of a laser beam to a workpiece, there is no teaching or suggestion for the integration of a GPS with an ultrasonic testing system which comprises a laser source and data acquisition system which is operated remotely from the workpiece as well as the end of the mechanical armature of the GPS.

The present invention provides several benefits including a scaleable laser beam delivery system which is adaptable to gantry positioning systems (GPSs) of various sizes and weight by providing closed-loop error correction of the transmission of a laser beam provided by a remote laser source through a GPS. By performing scanning across the test object from multiple fields of view, the present invention provides for automated data acquisition of a test object for detecting material defects using ultrasonic techniques. Additionally, a laser beam conditioning system may be used to control various laser beam properties during transmission through the GPS and as the laser beam exits the GPS and travels toward the test object.

An additional embodiment of the present invention improves some of the robotic automation capabilities of a laser ultrasonic testing system. Some advantages provided by the present invention include the ability to have automated scan-plan definition from CAD models to optimize laser ultrasonic testing performance. The present invention also provides for automated methods of part location in the work envelope with scan-plan transformations. Laser ultrasonic testing image data can be mapped to a measured and/or CAD generated 3D surface.

The present invention also provides calibration procedures for measuring the laser ultrasonic testing beam vector in absolute coordinates. The present invention also provides for robotic collision avoidance methods. The present invention also provides for thermographic analysis of thin and/or bonded composite assemblies and the integration of thermographic sensors with the laser ultrasonic testing gantry robotic system.

Additionally, the present invention provides robotic methods for articulating a laser ultrasonic testing sensor inside a complex inlet structure and for depot or field deployed laser ultrasonic testing systems.

### I. Automated Scan-Plan Definition

The present invention defines robotic position and optical scan-plans for optimum laser ultrasonic robotic repositions.

The present invention provides the benefits of improved data quality, increased throughput, and reduced labor costs. The benefits are achieved through the use of integrated software tools compatible with the current CATIA CAD package and the laser ultrasonic testing host SGI computing environment.

The present invention has the ability to locate a part to be tested in the work envelope with sufficient accuracy to implement the scan-plan identified above. Primarily this corrects for small errors on the order of a few inches and less than 10 degrees of rotation due to manual positioning of the part and holding fixture in the cell. This adaptive process allows low-cost part fixturing and positioning procedures to be used, allowing the benefits of increased throughput and reduced labor costs. Through the use of integrated hardware and software tools compatible with the laser ultrasonic testing system head configuration and the host SGI computing environment.

The present invention has the ability to map laser ultrasonic testing image data. Flat-field laser ultrasonic testing scan data can be projected onto a true 3D surface. This accurately associates ultrasonic data with the true measurement point on the surface. This can be implemented in several ways. First, an integrated measurement system can be used for measuring the surface geometry and providing a one-to-one map between the laser ultrasonic testing data and the measured 3D surface coordinate. Second, the location of the part in the work cell along with the CAD geometry can be used to map the data to the surface. This 3D reconstructed image clearly indicates if the scan coverage is complete and will display proper spatial registration of the individual laser ultrasonic testing scan regions on the part surface.

In the first method, parts without CAD generated scan-plans may be tested and approximately reconstructed based on real-time, or near real-time, distance range measurements. This has some advantages in maintaining the highest degree of operational flexibility for true autonomous testing of a wide selection of parts where CAD models may be unavailable. Additionally, one-of-a-kind evaluations can be easily performed. Although a distance range measurement is the most obvious method to locate the surface, other vision-based methods could be considered.

A second method is not dependent on point-by-point reconstruction based on measured values but instead is concerned with the orientation of the part relative to the laser ultrasonic testing scan view. The principle errors in this method arise from the accuracy that the component is located within the work cell and the positioning/pointing errors of the laser ultrasonic testing sensor.

This provides the benefits of improved data interpretation capabilities, reduced labor cost due to improved analysis features, increased throughput, enhanced testing capabilities for complex structures, and improved archive format for use as reference baseline on subsequent in-service inspections. Potential for automated image comparison directly between different parts or the same part at different service intervals.

The present invention provides a calibration method for 3D beam-pointing. This measurement and calibration procedure corrects for errors in the beam-pointing vector of the laser ultrasonic testing system. This includes all errors due to the 5-axis gantry positioning system and from the optical alignment and pointing of the two-axis optical scanner. This information can be used as required to generated corrected 3D reconstructed images.

Additionally, the present invention provides robotic collision avoidance methods. A collision avoidance system for the pars gantry robot includes the ability to avoid both permanent and temporary objects. Permanent objects include the gantry structure and other fixed hardware inside the work envelope. Temporary objects include parts, part fixtures, and transportation carts. These provide a significant improvement in avoiding mechanical disaster. Current estimate for downtime due to severe robotic collision is as high as 8 weeks.

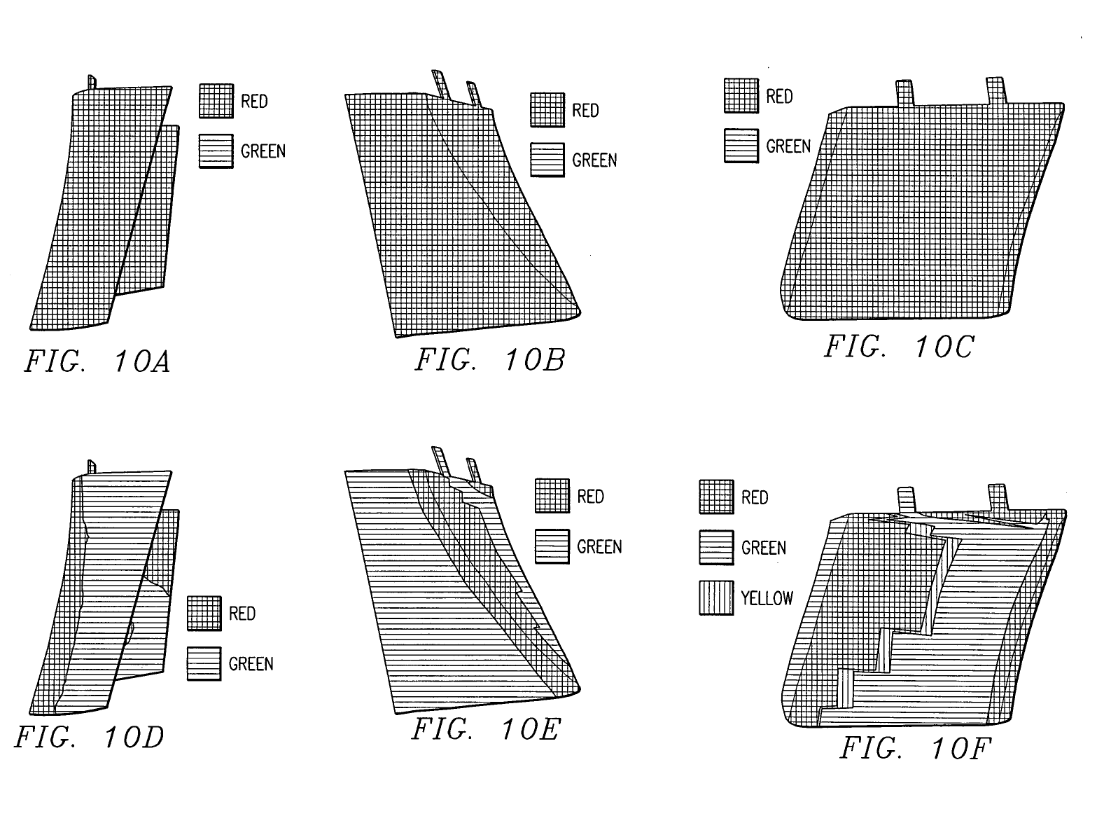

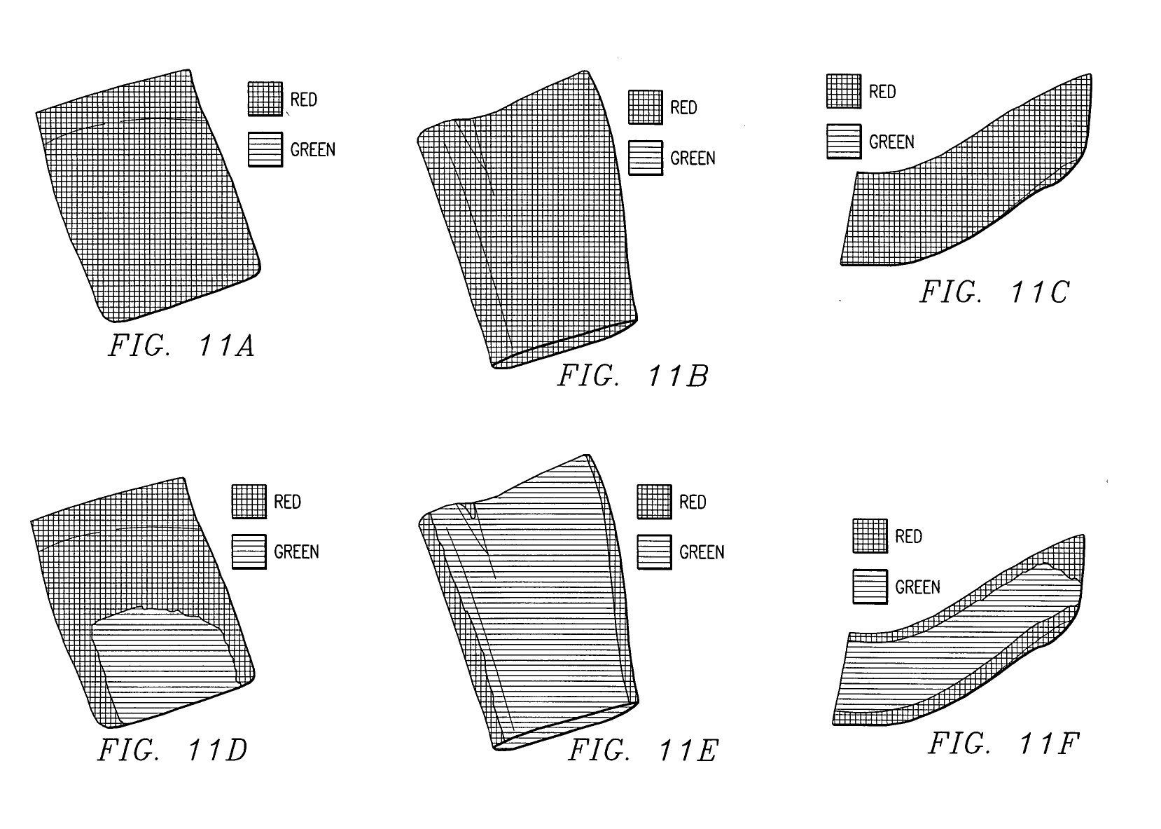

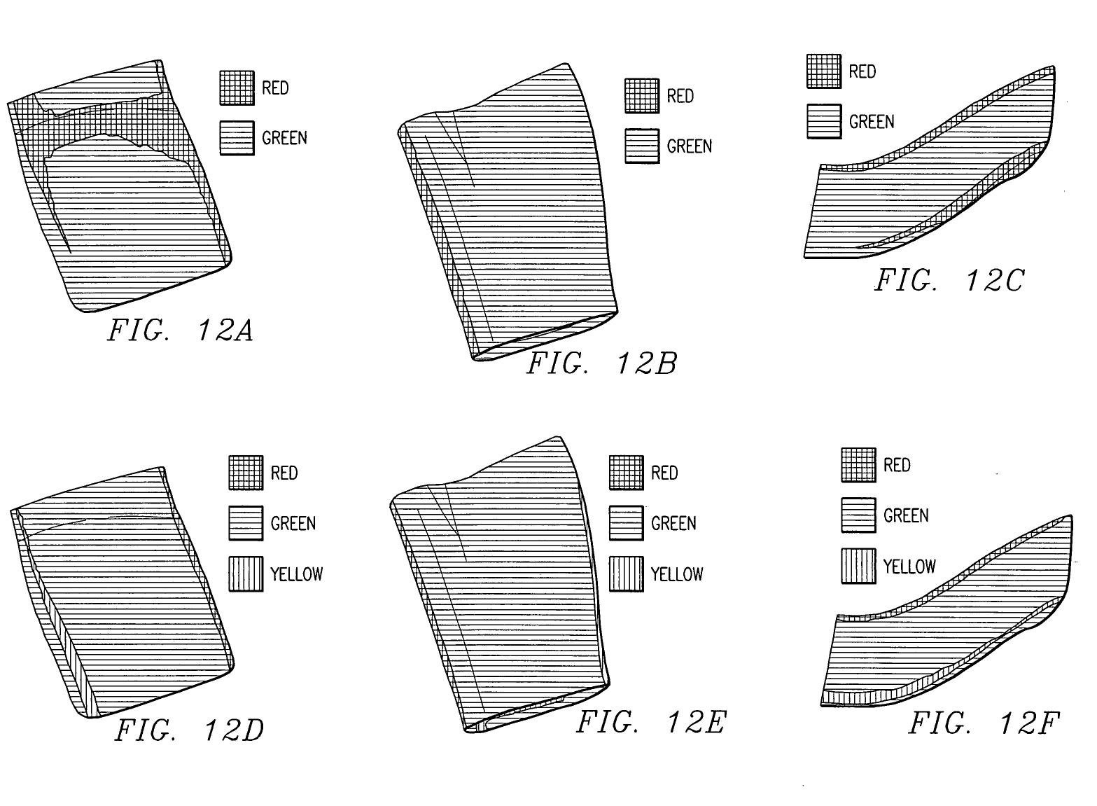

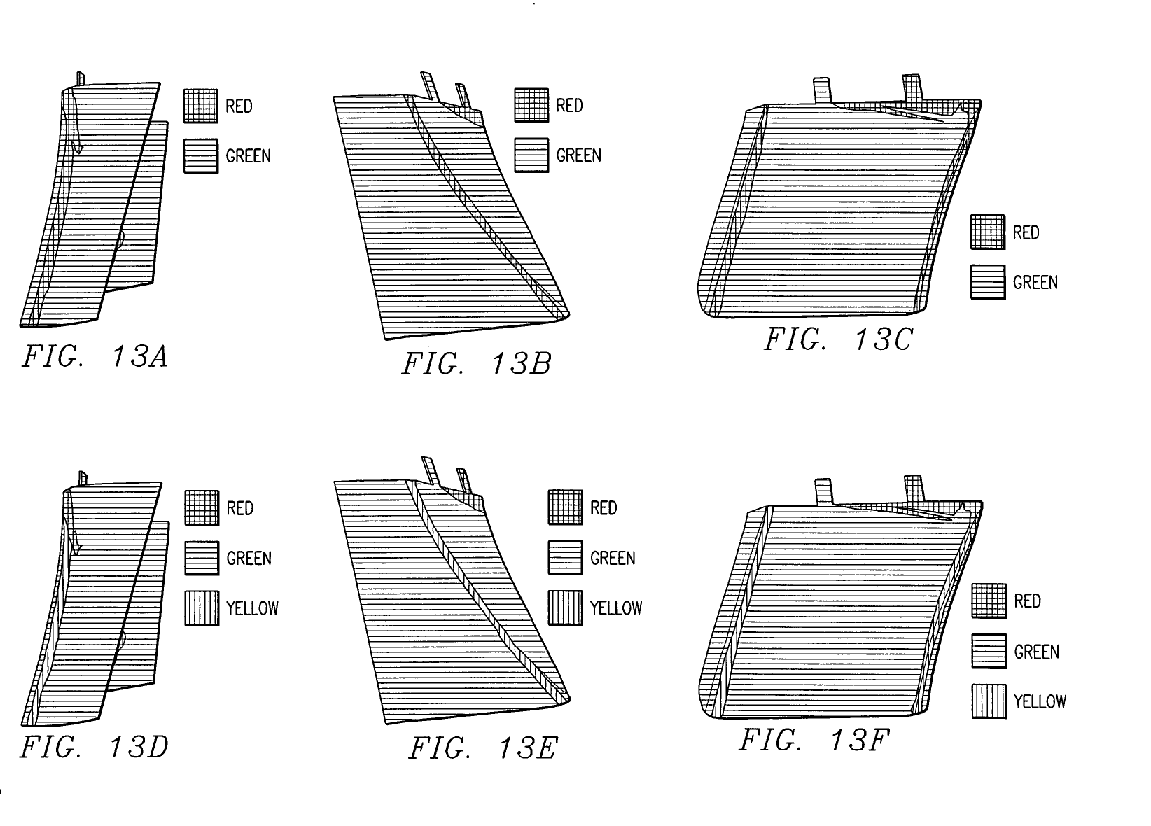

FIGS. 10A-F, 11A-F, 12A-F, and 13A-F depict various scan of parts and their results. Thus for a given orientation of the part, a processor can evaluate the coverage of an individual scan plan. Thus 100% coverage can be achieved through a series of scans, where the part and or the sensors of the present invention are reorientated. In these instances, results are pieced together in order to achieve the necessary coverage.

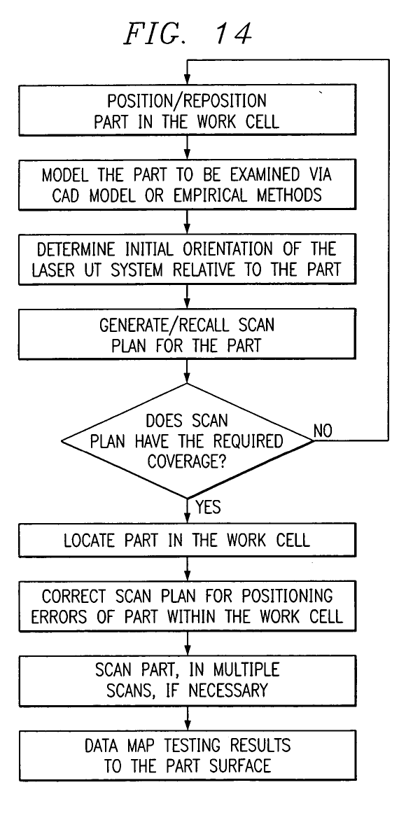

FIG. 14 depicts a flow chart illustrating the method of the present invention.

The present invention defines robotic position and optical scan-plans for optimum laser ultrasonic testing performance. The optical scan plans can be generated based on the part geometry derived from CAD models, actual measurements, and FIGURE-of-merit parameters defined by laser ultrasonic testing limitations for a particular material type. Requirements may include:

(1) Defining part and fixture orientations in the work cell for repeatable low-cost positioning of the part (this may be a computer defined task based on part CAD models part center of gravity, holding fixture design, robotic reach, etc. Or it could be a task defined by the system operator where the part location and fixture design is manually defined based on experience);

(2) Maintaining an optimum distance to the part surface based on the system depth-of-field (for example 2.5 m+−0.5 m);

(3) Limiting laser angle of incidence (this will be material dependent, +−45 degrees for some, +−30 for others, also some materials may be extremely specular and on-axis views avoided);

(4) Verifying 100% part coverage with some overlap of scanned regions; and

(5) Optimizing throughput by scanning only areas where valid data can be collected with a minimum of robotic repositions.

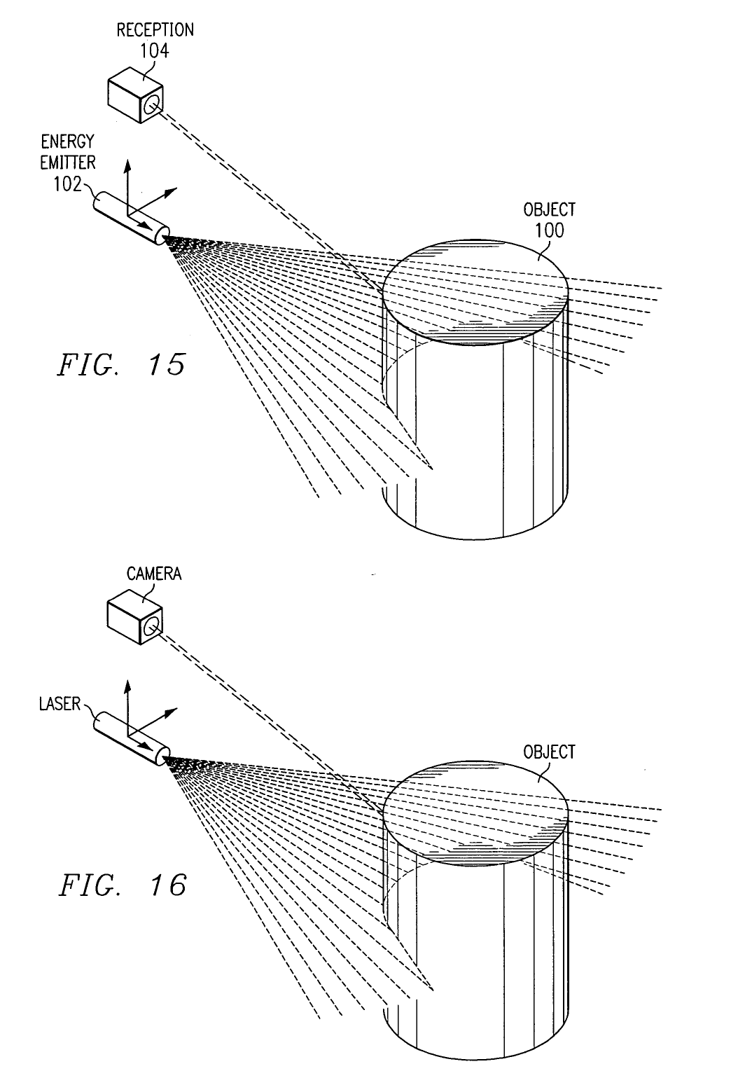

FIG. 15 is a diagram showing the operational units of an embodiment of the invention. An object 100 is to be scanned by the ultrasonic testing system. In the invention, an energy illuminator 102 bathes the object with some form of energy, and an energy reception mechanism that detects energy emanating from the object and associated with the energy imparted by the energy illumination device 102.

The illumination generator and the energy reception mechanism 104 are linked with each other in a predetermined spatial relationship. The predetermined spatial relationship may be fixed, such as being fixed together on one part, or the relationship may be alterable, with the energy receptive mechanism and the energy illumination generator being present on differing controllable bodies.

In any case, the energy reception mechanism is also associated with the energy generator of the testing mechanism in another predetermined spatial relationship. Again, the predetermined spatial relationship may be fixed, such as being fixed together on one part, or the relationship may be alterable, with the energy receptive mechanism and the energy illumination generator being present on differing controllable bodies.

Thus, when one fixes the points in free space where the part is relative to either of the illumination device or the reception device, one can fix the point and/or orientation of the testing device to that part as well. It should be noted that the results of the point and/or orientation detection may also be used in an actuator and control system. If the position of the testing device needs to be altered with respect to the tested object, the control system and actuator may use the results of this determination to move the testing device relative to the tested object.

The energy illumination generator generates energy and directs it to the object. The energy emanating from the object is detected by the energy receptive mechanism. The characteristics of the emanating energy may be determined, and a precise point on the object may be characterized due to these detected energies.

The energy illumination generator may be a laser, or other type of electromagnetic energy generator, such as a low power radar system. In the case of the radar energy, the energy receptive mechanism can determine the shape of the object, and since the energy receptive mechanism and the energy illumination generator have a predetermined spatial relationship, and another predetermined spatial relationship exists with respect to the energy generation device of the testing system, a precise location in space of the energy generation device may be derived from the measurement.

Relatedly, a sonar type system may be implemented as well. In this case, the energy would be sonic in nature, rather than electromagnetic.

In another embodiment, the energy illumination generator may be a visible light or laser. In this case, the energy receptive mechanism can be a camera, or electronic photo detector. In this manner, the precise position of the energy generation used for ultrasonic testing may be pinpointed in space. This can be accomplished prior to the testing phase, so that efficient sweeps of the object may be performed, or afterwards, such that corrections can be applied to the measurement of the object.

FIG. 16 is a diagram of a specific embodiment of the system of FIG. 15. In this embodiment, the energy illuminator is a laser or other type of source of visible electromagnetic energy, and the energy reception mechanism is a camera,

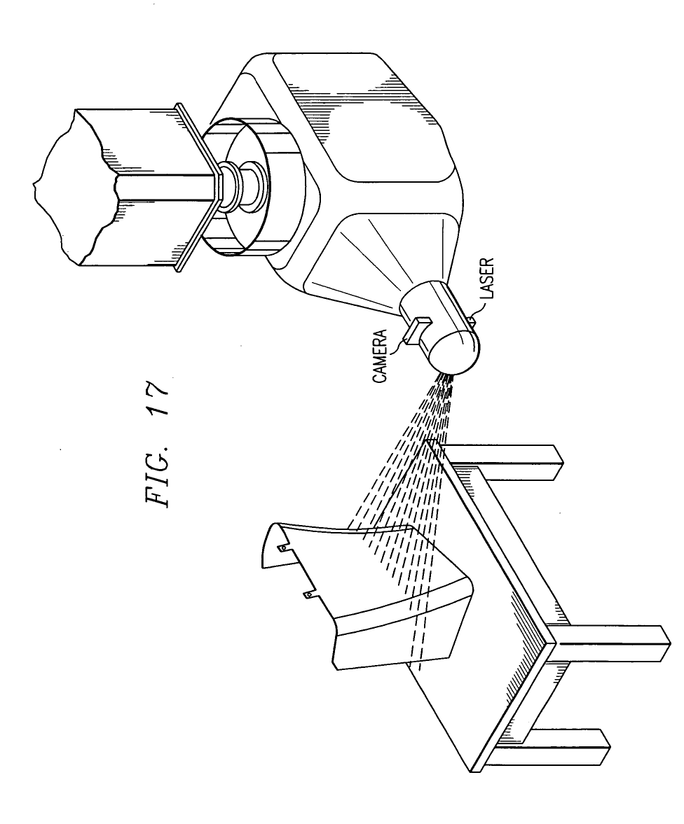

FIG. 17 is a diagram detailing the use of the system of FIG. 15 with a multi-axis laser generation system. The energy illumination generator laser and the energy receptive mechanism camera are co-located on a laser head that pivots and moves in space. The energy illumination generator laser can be the ultrasonic testing laser, or may be a different sort altogether.

FIGS. 18 and 19 are diagrams detailing the relationships inherent in the system of FIG. 15. FIG. 15 deals mainly with the optical type systems. Other relationships and equations may exist for other types of positioning systems, such as phase reversal equations, time reflectometry equations, and the like. From the diagram the relationships among the similar triangles yields the following results:

$$TAN a = \frac{y}{f}$$

$$TAN a = \frac{{D}_{2}}{Z} = \frac{D}{2 {Z}_{0}}$$

$$TAN ( {θ}_{0} - α ) = \frac{{D}_{1}}{Z} = \frac{D - {D}_{2}}{Z} = \frac{D - \frac{Z D}{2 {Z}_{0}}}{Z}$$

$$TAN ( {θ}_{0} - α ) = \frac{D - Z TAN {θ}_{0}}{Z} = \frac{D}{Z} - TAN {θ}_{0}$$

$$Z = \frac{D}{TAN ( {θ}_{0} - α ) + TAN {θ}_{0}}$$

$$Z ( y ) = \frac{D}{TAN [ {TAN}^{- 1} ( \frac{D}{2 {Z}_{0}} ) - {TAN}^{- 1} ( \frac{y}{f} ) ] + \frac{D}{2 {Z}_{0}}}$$

This way may derive several relationships. These relationships include:

$${θ}_{0} ≅ \frac{D}{2 {Z}_{0}} AND α ≅ \frac{y}{f} ⇒ TAN ( {θ}_{0} - α ) ≅ {θ}_{0} - α$$

$$Z ( y ) ≅ \frac{D}{\frac{D}{{Z}_{0}} - \frac{y}{f}} ≅ \frac{Z}{1 - \frac{y {Z}_{0}}{D f}}$$

$$\frac{ⅆ Z}{ⅆ y} = \frac{- {Z}_{0}}{{[ 1 - \frac{y {Z}_{0}}{D f} ]}^{2}} [ - \frac{{Z}_{0}}{D f} ] = \frac{{Z}_{0}^{2}}{D {f [ 1 - \frac{y {Z}_{0}}{D f} ]}^{2}}$$

$$ⅆ Z = \frac{{Z}_{0}^{2} ⅆ y}{D {f [ 1 - \frac{y {Z}_{0}}{D f} ]}^{2}}$$

Thus, several basic equations arise from the optical system thus described. The basic equations are:

$$Z [ 1 - \frac{y {Z}_{0}}{D f} ] = {Z}_{0}$$

$$\frac{y {Z}_{0} Z}{D f} = Z - {Z}_{0}$$

$$y = D f ( \frac{1}{{Z}_{0} Z} ) ( Z - {Z}_{0} ) = D f ( \frac{1}{{Z}_{0}} - \frac{1}{Z} )$$

$$ⅆ Z ( y ) = \frac{{Z}_{0}^{2} ⅆ y}{D {f [ 1 - \frac{y {Z}_{0}}{D f} ]}^{2}}$$

$$ⅆ Z ( Z ) = \frac{{Z}_{0}^{2} ⅆ y}{D {f [ 1 = ( 1 - \frac{{Z}_{0}}{Z} ) ]}^{2}} = \frac{{Z}_{0}^{2} ⅆ y}{D {f [ \frac{{Z}_{0}}{Z} ]}^{2}} = \frac{{Z}^{2} ⅆ y}{D f}$$

$$ⅆ Z ( Z ) = \frac{{Z}^{2} ⅆ y}{D f}$$

Thus, in relation to FIG. 19, the following design equations also aid in the determination of the proper system parameters. These include:

$$TAN ( \frac{FOV}{2} ) = \frac{L}{2 f}$$

$$FOV = 2 {TAN}^{- 1} ( \frac{L}{2 f} )$$

$$ⅆ y = \frac{L}{NUM . ELEMENTS}$$

In a numerical example

L=0.5″CCD ARRAY FOV≅40° [symbol] f=0.68″(17.3 mm)

$$N = 1024 ⇒ ⅆ y = \frac{0.5}{2048}$$

D=18″

$$ⅆ Z ( Z ) = 2 \times {10}^{- 5} ( \frac{1}{in} ) {Z}^{2}$$

dZ(60)=0.072″

dZ(100)=0.2″

Thus, the optic system of FIGS. 18 and 19 can determine the spatial orientation of the part with a high degree of precision. As such, the results of spatial profiling system can be used in a control circuitry to move relative positions of the object and testing system.

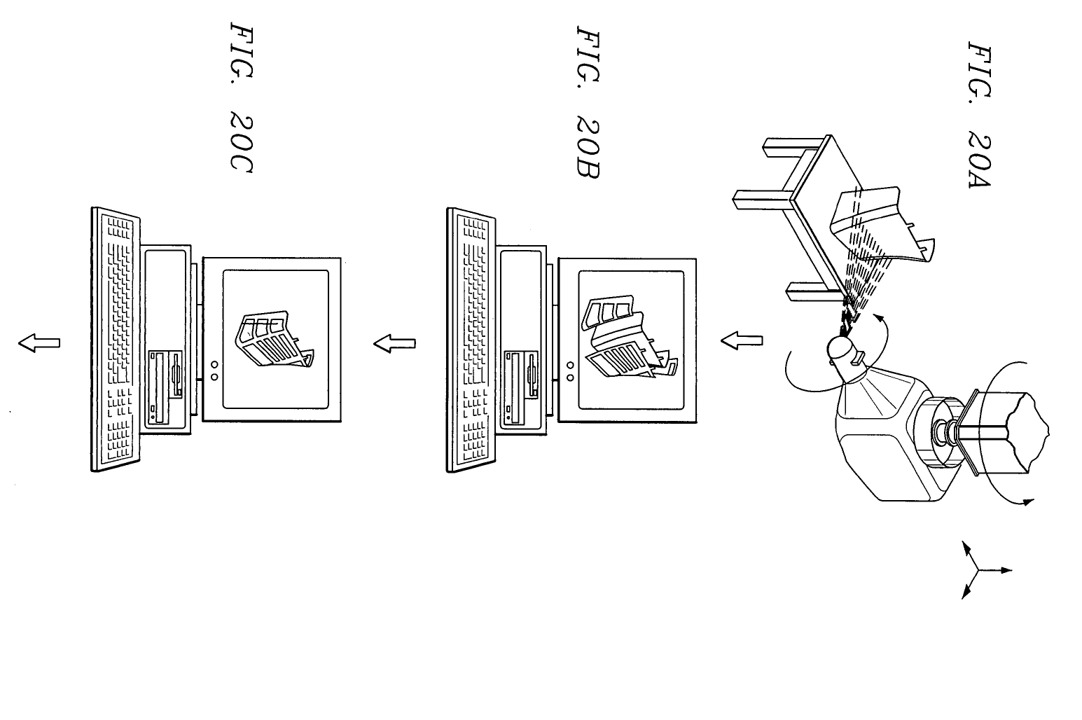

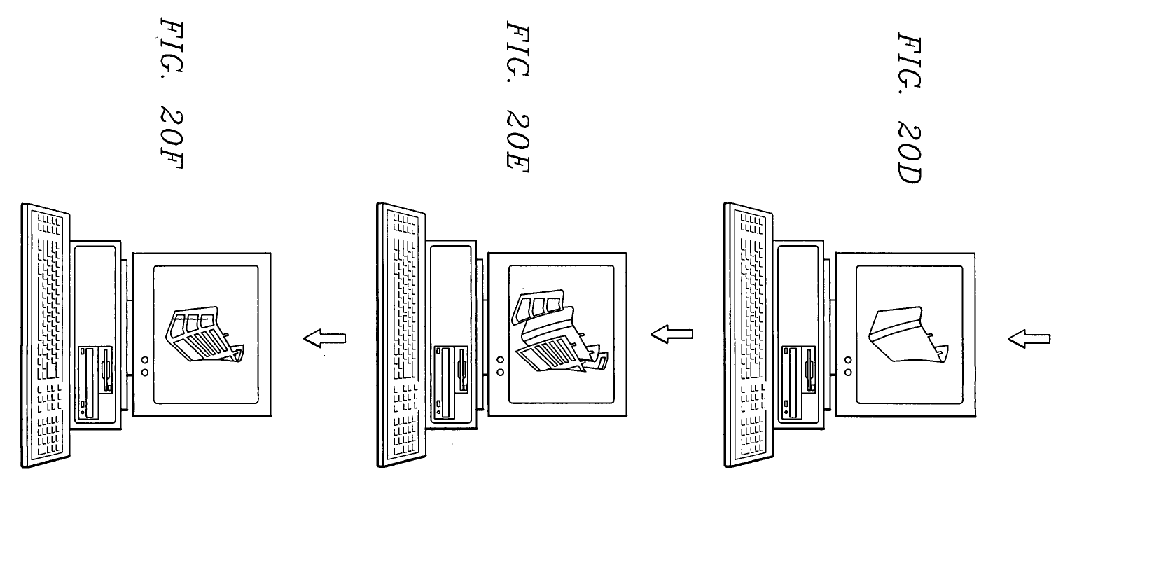

FIGS. 20A-F are diagrams detailing a process of how the system of FIG. 15 can operate. In one embodiment of the invention, as associated CAD device supplies a representation of the tested part to the system. The head of the laser testing assembly has multiple degrees of kinetic freedom, allowing the head to be positioned very precisely.

In this embodiment, the testing head is placed in proximity with the part to be tested, and the system then determines the proper positioning corrections for the testing to begin. The testing implement is then positioned properly with relation to the object and the testing process begins.

The CAD generated surface is then melded with the testing results. This enables an operator to quickly and easily identify features associated with the tested object, such as faults, stresses, imperfections, and the like. Or, instead of specific points, the testing data may be compared in a scale of acceptable versus unacceptable. In this case, the shaded area might indicate areas that fail to reach threshold testing. This could be used to identify specific manufacturing steps that need to be assessed or changed.

In another related embodiment, the testing of the part may generate results for a specific area of the part. The entire part may be quickly tested, since the precise positioning mechanism allows the testing system to minimize the overlap associated with specific individual testing actions. This could dramatically increase the speed at which parts are tested.

It should be noted that the system need not position the testing device. The system can be used to position the part, or the testing device, either singly or in combination. The energy illumination generator and the energy receptive mechanism may also exist on separate frames or supports than the positioning system. For example, the energy illumination device and the energy-receiving device may be positioned on supports of the gantry system. This system may move the object within the gantry system or may move the testing device, or both.

It should be noted that this system might be used in any testing system that generates ultrasonic energy. While a laser based system is described, it should be noted that other forms of testing based on reading emitted energy should be encompassed by the invention.

Although the present invention has been described in detail, it should be understood that various changes, substitutions and alterations can be made hereto without departing from the spirit and scope of the invention as described by the appended claims.

What is claimed is:

1. An apparatus for intact testing of an object, comprising, in combination:
means for scanning the intact object, said scanning means mounted on a robot, said robot free standing with respect to the object; and
comparison means to correlate data from the scanning means to a standard.

2. The apparatus of claim 1, wherein said scanning means includes means to move in three linear directions and about at least two axes.

3. The apparatus of claim 2, wherein said scanning means includes means to move in three linear directions and about three axes.

4. The apparatus of claim 1, further including means to align said robot relative to the object.

5. The apparatus of claim 1, wherein said robot includes a scanning head with means to move in three linear, orthogonally offset directions and at least two rotational directions.

6. The apparatus of claim 5, wherein said robot includes a scanning head with means to move in three linear, orthogonally offset directions and three rotational directions.

7. The apparatus of claim 1, further including collision-avoidance means on said scanning means to prevent gross contact with the object.

8. The apparatus of claim 1, wherein said scanning means includes ultrasonics.

9. An apparatus for intact testing of an object, comprising, in combination:
means for scanning the intact object mounted on a robot; and
comparison means to correlate data from the scanning means to a standard;
a structure configured to contain said apparatus and said object under inspection;
said apparatus is coupled to said structure, resulting in the formation of a gantry for supporting a carriage, a mast mounted on said carriage and at least one of an emitter and detector mounted on said mast which forms in part at least one inspection robot capable of precise positioning over large ranges of motion;
said at least one inspection robot further comprises a beam structure for supporting and allowing horizontal translation of said carriage;
said carriage is coupled to said mast, wherein said mast supports and allows a vertical translation of said at least one of the emitter and detector mounted on said mast, and wherein said mast is configured to provide yaw movement of said at least one of the emitter and detector; and
said at least one of the emitter and detector is configured to provide rotation about at least one axis of roll and yaw motion of said at least one emitter and detector.

10. The apparatus of claim 9, wherein said scanning means includes ultrasonics.

11. The system of claim 9, wherein at least one of the emitter and detector is configured to provide rotation about an axis of pitch motion of said at least one emitter and detector.

12. The system of claim 9, wherein said at least one of the emitter and detector is configured to a yoke to provide rotation about at least one axis of pitch and roll motion of said at least one of the emitter and detector.

13. An apparatus for intact testing of an object, comprising, in combination:
means for scanning the intact object mounted on a robot;
comparison means to correlate data from the scanning means to a standard;
a structure dimensioned to receive the object therewithin;
said robotic scanning means supported by said structure and including means to move a scanning head of said robotic scanning means in three linear directions and at least two rotational directions;
means to initialize said scanning head both with respect to said robot and with respect to the object; and
means to correlate data derived from scanning the object to a standard.

14. The apparatus of claim 13, wherein said robotic scanning means including means to move the scanning head of said robotic scanning means in three linear directions and three rotational directions.

15. The apparatus of claim 13, further comprising means to hold the object in a constant position.

16. The apparatus of claim 15, further comprising means to assess gross distortion of object geometry.

17. The apparatus of claim 16, further comprising said scanning head generating a laser scan.

18. The apparatus of claim 16, further comprising said scanning head generating an electromagnetic scan.

19. The apparatus of claim 16, further comprising said scanning head generating a radar scan.

20. A method for testing an object for present or potential defects, comprising:
scanning the object with a sensor means to generate data for the object;
comparing the data for the object for correlation with reference data;
identifying any defects as a result of the comparison.

21. The method of claim 20, wherein the sensing means includes a robot for sensing, monitoring at least one sensor on the robot, and moving the at least one sensor in X, Y, or Z directions and/or about at least two axes.

22. The method of claim 21, wherein the robot is moved about any of a pitch, roll, and yaw axis.

23. The method of claim 20, wherein the sensing means employs ultrasonics.

24. The method of claim 20, further comprising:
initializing the sensing means relative to a fixed spot in order to precisely locate the object.

25. The method of 24, further comprising:
updating the comparison with other data associated with the object to provide trend analysis.
